(19) United States
(12) Patent Application Publication
(10) Pub. No.: US 2014/0096690 A1
(43) Pub. Date: Apr. 10, 2014

(54) JUICE EXTRACTOR

(71) Applicant: Young Ki Kim, Gyeongsangnam-do (KR)

(72) Inventor: Young Ki Kim, Gyeongsangnam-do (KR)

(21) Appl. No.: 14/122,919

(22) PCT Filed: Mar. 29, 2012
(86) PCT No.: PCT/KR2012/002327

§ 371 Date: Dec. 20, 2013

(30) Foreign Application Priority Data
Jun. 14, 2011 (KR) 10-2011-0057564

(51) Int. Cl. A23N 1/02

(52) U.S. Cl. CPC A23N 1/02
USPC 99/513

(57) ABSTRACT

A juice extractor, which is configured in such a way that the cross-sectional area of a feed tube is larger than the cross-sectional area of a feed port of a hopper, so that an input material that is used to make juice and which is put into the feed port can be directly dropped onto the lower portion of the feed tube without staying in the feed tube, thereby allowing a user to easily make juice without having to manually push the input material using a pusher.

### TECHNICAL FIELD

The present invention relates to a juice extractor that can make juice from vegetables or fruits.

### BACKGROUND ART

In recent years, with the increased interest in well-being, many people are personally Making green vegetable juice or fruit juice from fresh vegetables or fruits. Thus, there are various juicers for making fruit juice and green vegetable juice that are available and whose purpose is to easily make fruit juice or green vegetable juice at home.

An example of such a juice extractor is the one proposed in Korean Patent No. 609390, which was filed by the applicant of this invention and registered. FIG. 1 is a sectional view showing the configuration of a conventional juice extractor. As shown in FIG. 1, the juice extractor 1 is configured so that a long feed screw 30 is horizontally assembled in a housing 10, together with a strainer 40, to be coupled to a sidewall of a driving unit by a rotating shaft 31. When the material used to make the juice is put into a feed port 21 of a hopper and reaches a lower end of a feed tube 20, the feed screw 30 slowly feeds the material horizontally while extracting juice.

In the conventional juice extractor, to prevent juice from being undesirably discharged along with the discharged residue, a hard cylindrical control part 85 of a control cap 80 is biased rightwards and compresses the residue that is being discharged through a space defined between the feed screw 30 and the cylindrical control part 85. Further, to realize a desired juice extraction ratio according to the kind of input material, the conventional juice extractor is configured so that the level of the force that biases the hard cylindrical control part 85 rightward scan be controlled by the elasticity of a spring or a rubber packing 90 in response to a rotating angle of the control cap 81.

However, in the related art, when a child puts a material used to make juice into the feed port 21, a hand of the child may be put into the feed tube 20 and may be injured by the rotating feed screw 30, so that in order to prevent children from being injured by the feed screw, the size of the feed port 21 is limited so as not to exceed a reference size predetermined according to safety regulations. However, in the related art, the juice extractor has been designed in such a way that the feed port and the feed tube have the same cross-sectional area, so that when a material used to make juice is put into the feed port, the material may easily and frequently stay in the middle portion of the feed tube and this forces a user to manually push the material using a pusher so as to prevent the material from staying in the feed tube.

### DISCLOSURE OF INVENTION

### Technical Problem

Accordingly, the present invention has been made keeping in mind the above problems occurring in the related art, and a purpose of the present invention is to propose a juice extractor which is configured in such a way that although the cross-sectional area of the feed port is limited, the material that is used to make juice and is put into the feed port can be directly dropped onto a lower portion of the feed tube without staying in a middle portion of the feed tube, thereby allowing a user to easily make juice without manually having to push the input material using a pusher.

### Solution to Problem

In order to achieve the above object, according to one aspect of the present invention, there is provided a juice extractor including: a housing having a juice discharge port formed in a lower part thereof and an interior space defined therein; a strainer placed in the interior space of the housing and having both a crushing part and a discharging net a feed screw placed in the strainer and rotating in such a way that a rotating screw bar, which has spiral teeth and forms a part of the feed screw, can be rotated horizontally and a housing cap assembled with a control cap, wherein a cross-sectional area of a feed tube is larger than a cross-sectional area of a feed port of a hopper.

In the juice extractor, the hopper may be provided with a protruding rim formed around an inside edge of the feed port.

Further, in the juice extractor, the feed tube may have an elliptical cross-section in which a major axis crosses an axis of the rotating screw bar at right angles.

### Advantageous Effects of Invention

As described above, the juice extractor of the present invention includes: the housing having the juice discharge port formed in the lower part thereof and the interior space defined therein; the strainer placed in the interior space of the housing and having both the crushing part and the discharging net the feed screw placed in the strainer and rotating in such a way that the rotating screw bar, which has the spiral teeth and forms a part of the feed screw, can be rotated horizontally and the housing cap assembled with the control cap, wherein the cross-sectional area of the feed tube is larger than the cross-sectional area of the feed port of the hopper, so that the material put into the feed port so as to make juice can be directly dropped onto the lower part of the feed tube without staying in the middle portion of the feed tube, thereby allowing a user to easily make juice without manually having to push the input material using a pusher.

Further, in the present invention of this invention, the hopper is provided with the protruding rim formed around the inside edge of the feed port, so that the cross-sectional area of the feed tube is larger than the cross-sectional area of the feed port of the hopper and thereby both the hopper and the feed tube can be easily manufactured.

Further, in the juice extractor of this invention, the cross-section of the feed tube is elliptical. When viewed in cross-section, the major axis crosses the axis of the rotating screw bar at a right angle, so that there is no need to increase either the axial length of the rotating screw bar or the axial length of a rotating shaft of the feed screw, and thereby the length of the juice extractor of this invention can be reduced compared to a juice extractor having a cylindrical feed tube that has a cross-sectional area that is the same as that of the elliptical feed tube.

### BRIEF DESCRIPTION OF DRAWINGS

The above and other objects, features and further advantages of the present invention will be more clearly understood from the following detailed description when taken in conjunction with the accompanying drawings, in which:

FIG. 1 is a sectional view illustrating the construction of a conventional juice extractor;

FIG. 2 is an exploded perspective view illustrating the construction of a juice extractor according to the present invention;

FIG. 3a is a sectional view illustrating the construction of the juice extractor according to the present invention;

FIG. 3b is a sectional view illustrating a state in which the soft elastic body of the juice extractor according to the present invention is being compressed and

FIG. 4 is a sectional view of a housing of the juice extractor taken along line A-A of FIG. 2.

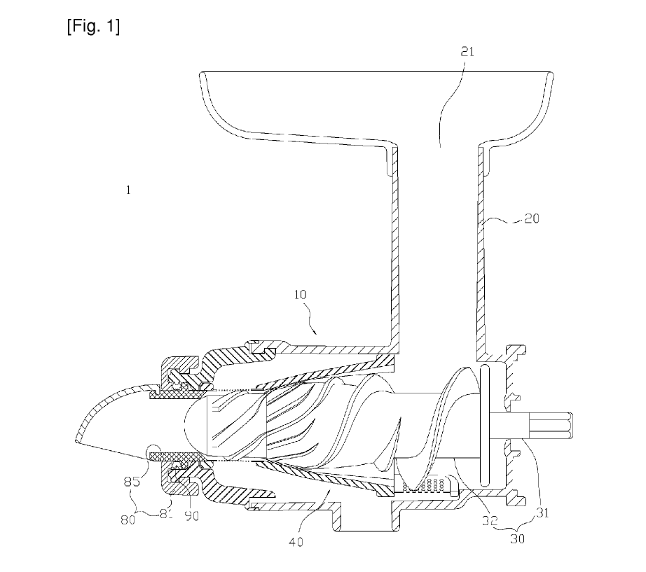

### MODE FOR THE INVENTION

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of my invention shown and described herein is to be taken as a preferred embodiment of the present invention and that various changes and modifications may be made in the invention without departing from the spirit and scope thereof.

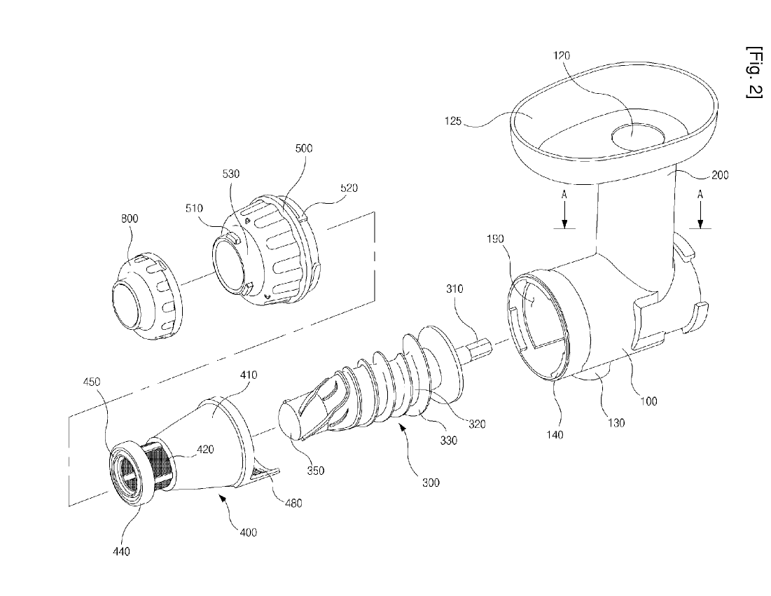

As shown in FIGS. 2 to 4, the present invention provides a juice extractor including: a housing having a juice discharge port formed in a lower part thereof and an interior space defined therein; a strainer placed in the interior space of the housing and having both a crushing part and a discharging net a feed screw placed in the strainer and rotated in such a way that a rotating screw bar thereof can be rotated horizontally, with spiral teeth being formed around the rotating screw bar and a housing cap assembled with a control cap, wherein the cross-sectional area of a feed tube is larger than the cross-sectional area of a feed port of a hopper.

In the juice extractor of this invention, the hopper is provided with a protruding rim formed around an inside edge of the feed port.

Further, in the juice extractor of this invention, the feed tube has an elliptical cross-section in which a major axis crosses an axis of the rotating screw bar at a right angle.

FIG. 2 is an exploded perspective view illustrating the construction of a juice extractor according to the present invention. As shown in FIG. 2, the juice extractor includes a housing 100, a feed screw 300, a strainer 400, a housing cap 500 and a control cap 800.

A feed tube 200 assembled with a hopper 125 is provided on the upper end of the housing 100, while a juice discharge port 130 for discharging juice is formed in a bottom of the housing 100, with an interior space 190 being defined inside the housing 100. The interior space 190 has a cylindrical shape and is preferably open in left and right ends. Further, in the left end of the housing 100 defining the interior space 190 therein, housing locking ribs 140 are provided so as to fasten the housing cap 500 to the housing 100. Further, a feed port 120 into which is put the material used to make the juice is formed in the upper end of the feed tube 200.

The hopper 125 is provided with a protruding rim 126 that is inwardly formed around an inside edge of the feed port 120, so that the cross-sectional area of the feed port 120 is smaller than the cross-sectional area of the feed tube 200. Here, it is preferred that the feed port 120 have a circular shape. Further, the directions in which the feed port 120 and the feed tube 200 are cross-sectioned are equal to the direction of the cross-section taken along line A-A shown in FIG. 2.

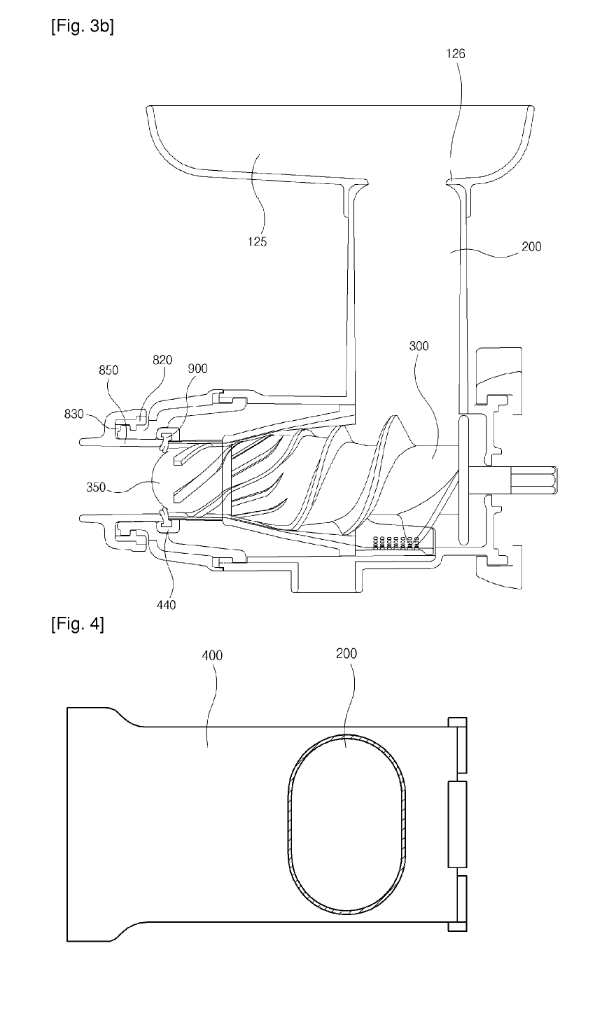

Further, it is preferred that the cross-section of the feed tube 200 be elliptical and that the major axis crosses the axis of the rotating screw bar at a right angle, as shown in FIG. 4.

The feed screw 300 includes: a rotating shaft 310 that protrudes outside from the right end of the housing 100 and receives a drive force from a driving device, such as an external motor (not shown), and a rotating screw bar 320 integrated with the rotating shaft 310 into a single body. The feed screw 300 is horizontally placed in the housing interior space 190 in such a way that the rotating screw bar 320 can be rotated horizontally, with spiral teeth 330 being formed around the rotating screw bar 320 so as to feed and crush the input material.

The strainer 400 includes a crushing part 410 and a discharging net 420 and is placed horizontally in the interior space of the housing 100. The crushing part 410 has a hollow conical shape and is placed so as to surround the feed screw 300, so that the crushing part 410 guides the input material that has been fed forwards (leftwards) by the feed screw 300, thereby crushing the material. The juice produced in the crushing part 410 by the crushing function of the feed screw 300 flows to the juice discharge port 130 through a filtering net 480 that is provided in a rear end of the crushing part 410, and is then discharged to the outside through the juice discharge port 130. The discharging net 420 extends forwards (leftwards) from the crushing part 410 and comes into contact with the outer surface of the distal end 350 of the feed screw 300 and discharges the residue of the material to the outside.

The left end surface of the strainer 400 is provided with a side ring 440. In the side ring 440, a ring insert groove 450 for holding a part of a soft elastic ring 900 is formed.

The housing cap 500 is provided with a central opening. Locking protrusions 520 for fastening the housing cap 500 to the housing locking ribs 140 of the housing 100 are formed around an outer circumferential surface of one end of the housing cap 500, while a flange 530 over which the control cap 800 is fitted is formed in the end of the housing cap 500. Further, taper protrusions 510 are formed around the outer circumferential surface of the flange 530.

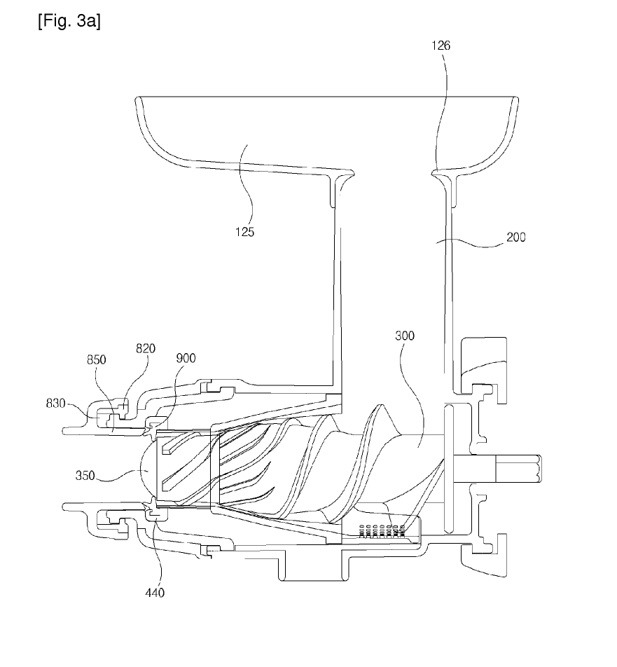

In the control cap 800, a cylindrical control part 850 having a central opening is formed. A recessed part 830 is formed around the cylindrical control part 850, so that the flange 530 is fitted into the recessed part 830. On the inner surface of the recessed part 830, inclined surface protrusions 820 having respective inclined surfaces are formed and engage with the taper protrusions 510. Here, the inclined surface protrusions 820 are inclined in circumferential directions in such a way that when the control cap 800 is rotated, the control cap 800 can be moved to the left or right by the cooperation of the inclined surface protrusions 820 and the taper protrusions 510, as shown in FIGS. 3a and 3b.

Here, the cylindrical control part 850 and the recessed part 830 of in the control cap 800 may be integrated into a single body.

The soft elastic body 900 has a ring shape and is held by the side ring 440 that is Formed on the end of the strainer 400. Here, it is preferred that the soft elastic body 900 be inserted into the ring insert groove 450 formed in the side ring 440, so that the soft elastic body 900 can be continuously retained at the desired location.

The operation of the juice extractor according to the present invention will be described herein below.

When the material used to make juice is put into the feed port 120 that is formed in the feed tube 200 of the juice extractor 100, the input material is fed to the left in the housing 100 by the feed screw 300. When the input material is fed to the left, the material is crushed between the feed screw 300 and the crushing part 410 and juice produced by the crushing operation flows to the juice discharge port 130 through the filtering net 480 that is provided in the rear end of the crushing part 410.

The material that has been processed by the crushing part 410 is continuously fed forwards by the rotation of the feed screw 300 and is discharged to the outside via the discharging net 420 by the rotating of the feed screw 300.

When the control cap 800 that is rotatably fitted over the front end of the housing cap 500 is rotated, the control cap 800 is moved forwards or backwards relative to the housing cap 500 by the function of the inclined surfaces of the inclined surface protrusions 820 that are formed on the control cap 800 and are engaged with the taper protrusions 510 of the housing cap 500, so that the cylindrical control part 850 of the control cap 800 compresses or releases the soft elastic ring 900 and changes the force compressing the distal end 350 of the feed screw 300, thereby controlling the residue discharging force of the juice extractor. In other words, a user can finely control the residue discharging force of the juice extractor by rotating the control cap 800 according to a kind of input material.

As described above, the material that has been processed while being fed to the front of the juice extractor by the rotation of the feed screw 300 passes through the cylindrical control part 850 and is discharged downwards from the front end of the juice extractor.

Further, the cross-sectional area of the feed port is limited according to the safety regulations and by the amount of material that should be put into the feed port 120 in the juice extractor of this invention. Furthermore, the present invention is configured in such a way that the cross-sectional area of the feed tube 200 is larger than the cross-sectional area of the feed port 120 of the hopper, so that even when the amount of input material temporarily exceeds the juice extraction capacity of the juice extractor, the feed tube 200 can contain the material therein because the interior space of the feed tube is larger than that of a conventional feed tube. Accordingly, the height of the material staying in the feed tube 200 can be remarkably reduced compared to the conventional tube and, thereby, in the present invention, the input material can be directly and efficiently dropped to the lower part of the feed tube without staying in the middle portion of the feed tube or blocking the feed tube, so that a user can easily make juice without manually having to push the input material using a pusher.

Further, in the juice extractor of this invention, the hopper is provided with the protruding rim formed around the inside edge of the feed port, so that the cross-sectional area of the feed tube is larger than the cross-sectional area of the feed port of the hopper and thereby both the hopper and the feed tube can be easily manufactured.

Further, in the juice extractor of this invention, the feed tube has the elliptical cross-section in which the major axis crosses the axis of the rotating screw bar at a right angle, as shown in FIG. 4, so that neither the axial length of the rotating screw bar nor the axial length of a rotating shaft of the feed screw have to be increased. Accordingly, the present invention can reduce the length of the juice extractor compared to a juice extractor in which the cylindrical feed tube has the same cross-sectional area as the elliptical feed tube.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A juice extractor, comprising: a housing having a juice discharge port formed in a lower part thereof and an interior space defined therein; a strainer placed in the interior space of the housing and having both a crushing part and a discharging net a feed screw placed in the strainer and rotated in such a way that a rotating screw bar, which has spiral teeth on a periphery thereof, of the feed screw can be rotated horizontally and a housing cap assembled with a control cap, wherein a cross-sectional area of a feed tube is larger than a cross-sectional area of a feed port of a hopper.

2. The juice extractor as set forth in claim 1, wherein the hopper is provided with a protruding rim formed on the feed port.

3. The juice extractor as set forth in claim 1, wherein the feed tube has an elliptical cross-section in which a major axis crosses an axis of the rotating screw bar at a right angle.
